(19) United States
(12) Patent Application Publication
(10) Pub. No.: US 2026/0145775 A1
(43) Pub. Date: May 28, 2026

(54) Aerodynamic Profile body and associated flying object

(71) Applicant: Deutsches Zentrum Fur Luft- und Raumfahrt e.V., Bonn-Oberkassel (DE)

(72) Inventor: Jan Tikalsky, Barleben (DE)

(21) Appl. No.: 19/320,131

(22) Filed: Sep. 5, 2025

(30) Foreign Application Priority Data
Sep. 5, 2024 (DE) 10 2024 125 738.5

(51) Int. Cl. B64C 3/48; B64C 3/14; B64C 3/20; B64C 9/02; B64C 13/16

(52) U.S. Cl. CPC B64C 3/48; B64C 3/14; B64C 3/20; B64C 9/02; B64C 13/16

(57) ABSTRACT

The invention relates to an aerodynamic profile body with an outer flow surface for flow through a fluid, wherein the aerodynamic profile body comprises:
a first surface layer and a second surface layer, which form at least part of the outer flow surface and are designed to be flexible in an end section of the aerodynamic profile body,
a connection arrangement that flexibly connects the first surface layer to the second surface layer of the profile body in the end section, and
an actuator device with at least one actuator provided in an interior of the aerodynamic profile body which interacts with at least one of the surface layers in the flexible end section in such a way that the cross-section of the aerodynamic profile body in the flexible end section can be changed by the at least one actuator,
   characterized in that
the outer flow surface of at least one of the surface layers in the flexible end section has, at least in sections, a surface profile that extends parallel to the direction of flow.

The invention relates to an aerodynamic profile body with an outer flow surface for flow through a fluid. The invention also relates to an associated flying object.

Such an aerodynamic profile body can have a front edge section, a main section connected to it and a rear edge section connected to said main section. The outer flow surface is formed by a first surface layer and a second surface layer that extends from the front edge section, across the main section, to the rear edge section, preferably in a single piece. However, it is also conceivable that the first surface layer and the second surface layer are designed to be continuous.

The shape of an object not only plays an important role with regards to design, but in many cases it is also decisive from a technical perspective. For example, in the case of aircraft wings it is crucial that the shape of the wings has the necessary aerodynamic properties to generate the required lift. A stable shape is essential here, not only for safety reasons.

However, it is precisely in the area of aircraft wings that rigid shapes reveal their greatest disadvantage, namely that they cannot be changed. This is because it is desirable for wings to exhibit different aerodynamic properties depending on the flight phase so that they can adapt most effectively to the respective flight phase. Therefore, wings of large commercial aircraft usually have high-lift aids (also referred to as landing flaps) that are extended during the take-off and landing phase, thereby increasing the lift surface of the wings. The cross-section of the profile of the wings changes in the process, which allows commercial aircraft to generate the required lift with the aid of the wings, even at low speeds, without having to worry about a stall.

However, with such high-lift aids the change in profile happens purely mechanically in such a way that the basic shape of the cross-section of the wings remains unchanged, while the high-lift aids represent additional mechanical elements that can be brought into a corresponding target position. The wings, however, do not actually change shape.

This results in two fundamental disadvantages. Firstly, the required mechanics and kinematics mean the introduction of a not inconsiderable weight into the structure of the wings, which contradicts the idea of lightweight construction in the aerospace industry. Secondly, the transitions between the unchangeable main structure and the changeable high-lift aids at the rear edges disrupt the flow surface of the profile, which fundamentally prevents the maintenance of laminar boundary layer flow. Such laminar boundary layer flow is, however, an objective for the purpose of reducing resistance and therefore reducing greenhouse gas consumption. There are therefore attempts to realize such high-lift aids not through mechanically extending high-lift aids, but by changing the shape of the cross-sectional profile.

This also applies to the ailerons, the vertical stabilizer and the horizontal stabilizer, which are often deflected only slightly, but very frequently, during flight.

The European patent application no. 2 006 936 discloses a wing structure with a changeable shape where the actual shape or profile of the wings can be changed to a limited extent without additional mechanical aids. To this end, two or more rows of connected cells are proposed, wherein a pressure is applied to the cells of a row. If a high pressure is now applied to the cells of the first row and a low pressure is applied to the cells of the second row, the profile of the wings changes to a desired first shape. However, if the pressure ratio of the rows of cells is reversed, the shape can be returned to the initial shape.

US 2005/0029406 A1 discloses an actuator, the length of which can be changed with the aid of pressure-tight cells. By applying pressure in particular cells, their shape is changed in such a way that it results in an overall change in length of the actuator. This allows hydraulic elements of a mechanical system to be replaced, such as an aileron of an aeroplane.

There is current research into wing profiles with a rear edge that is variable in shape in order to change the cross-section of the rear edge and to therefore possibly achieve a high-lift aid or to imitate the functionality of ailerons, vertical stabilizer and horizontal stabilizer. To this end, the surface layers (also known as wing skin) of the wing profiles are designed to be flexible and thus changeable in terms of shape such that, with the aid of actuators arranged inside the wing profile, the surface layers can be elastically deformed and the cross-section of the rear edge can be changed. In the process, not only is the cross-section of the overall profile changed, but also the cross-section of the rear edge whose shape can be changed, so that the actual geometric shape is changed, especially the geometric shape of the rear edge cross-section.

Such a wing profile is known, for example, from the subsequently published DE 10 2023 117 337.5. In this case, the surface layers are connected to one another at the end of the rear edge section via a flexible connection arrangement in the form of a flexure hinge such that changes in the shape of the cross-section result in a relative displacement of the first surface layer to the second surface layer. The tensions within the surface layers decrease as a result.

In order to achieve a change in the cross-sectional shape of the aerodynamic profile body, a force has to be applied vertically to the changing section of the profile body. This is simply not possible from the outside with a wing body. The vertical force that changes the profile body therefore has to be generated by an actuator device inside the profile body. Such an arrangement is disclosed in the subsequently published DE 10 2024 103 686.9, which describes an aerodynamic profile body in which an upper and the lower surface layer in the end section are designed to be flexible and the cross-sections of which can be changed by means of an actuator device arranged in the interior.

Deformation of the cross-section in the end section can result in tensile and compressive stresses across the span if the entire end section is not deformed across the entire span.

The aim of the present invention is therefore to propose an aerodynamic profile body with a corresponding actuator device by means of which the cross-sectional shape of the profile body can also be only partially changed.

According to the invention, the task is solved using the aerodynamic profile body in accordance with claim 1. Advantageous embodiments of the invention are then to be found in the corresponding sub-claims.

According to claim 1, an aerodynamic profile body with an outer flow surface for flow through a fluid is proposed, wherein the aerodynamic profile body comprises a first surface layer and a second surface layer, which form at least part of the outer flow surface and are designed to be flexible in an end section of the aerodynamic profile body; a connection arrangement that flexibly connects the first surface layer to the second surface layer of the profile body in the end section; and an actuator device with at least one actuator provided in an interior of the aerodynamic profile body, which interacts with at least one of the surface layers in the flexible end section in such a way that the cross-section of the aerodynamic profile body in the flexible end section can be changed by the at least one actuator.

According to the invention, the outer flow surface of at least one of the surface layers in the flexible end section has, at least in sections, a surface profile that extends parallel to the direction of flow.

Due to the profiling of the flow surface in the flexible end section of at least one of the surface layers, tensile and compressive stresses can be compensated during a deformation of the surface layers. The orientation of the profile parallel to the direction of flow also enables an unrestricted flow of the outer flow surface without significantly increasing flow resistance.

The cross-section of such a surface profile is, for example, a corrugated profile with an upper belt and a lower belt. The upper belt is oriented towards the outer flow surface, while the lower belt is oriented towards the interior. The upper belt and lower belt, i.e. the peaks and troughs of the corrugated profile, run parallel to the direction of flow.

The direction of flow is preferably defined in the depth direction.

The span of the profile body is understood to mean the longitudinal extension of the profile body starting from the fuselage or the attachment and then away from it. The depth direction describes the extension of the profile body in the plane of the direction of flow and the thickness direction or profile height describes the extension of the profile body transversely to the span and transversely to the depth direction.

If the wing body is a wing of an aircraft, the span is oriented towards to the transverse axis (pitch axis) of the aircraft, the wing depth direction is oriented towards the longitudinal axis (roll axis) of the aircraft and the wing thickness direction or profile height is oriented towards to the vertical axis (yaw axis).

The orientations on a vertical stabilizer are equivalent to this. The direction away from the fuselage is the span, the direction in the direction of flow is the depth direction, and the direction transverse to both is the thickness direction.

The longitudinal extension of the surface profile is therefore intended to be parallel to the depth direction of the profile body. A cross-section across the span exhibits the corresponding profile shape of the surface profile.

In the context of the present invention, the cross-section is a plane that is orthogonal to the span or to the two planes that extend across the span.

According to one embodiment, it is provided for that the outer flow surface of the at least one surface layer in the flexible end section is divided into a plurality of profile sections of the span, each of which has a surface profile extending parallel to the direction of flow.

This segmentation of the flow surface in the end section of the span into individual profile sections allows each of these profile sections, or at least two adjacent profile sections, to be actuated separately from the others.

According to one embodiment, for this purpose each profile section is operatively connected to at least one actuator of the actuator device in order to change the cross-section of the aerodynamic profile body in the respective profile section of the flexible end section.

The cross-section of the profile body can be changed specifically at various positions in the span. This allows an initial cross-sectional change in the profile body at a first position in the span to be modified, which differs from a second cross-sectional change, which is different from the first cross-sectional change, at a second position, which is different from the first position.

According to one embodiment, it is provided for that a connecting section is provided between two profile sections, wherein the outer flow surface of the at least one surface layer does not have a surface profile in the connecting section.

Here, it is especially advantageous if the actuators of the actuator device are operatively connected to said connecting section. It can be provided for that each connecting section is operatively connected to an actuator, thereby realizing a change in the cross-section of the two adjacent profile sections when the cross-section of the connecting section is changed by the actuator.

According to one embodiment, it is intended that the profile thickness of the surface profile increases towards to end section. The profile thickness is the distance in the cross-section between the upper belt and the lower belt. If the profile is a corrugated profile, one can refer to an amplitude that increases towards the end section.

This prevents jumps at the beginning of the surface profile in the flow surface, thereby preventing obstacles in the flow surface from increasing air resistance.

According to one embodiment, it is provided for that the connection arrangement comprises a flexible flexure hinge.

The end section of the profile body is considered an elastic system. The displacement of the first surface layer towards the second surface layer caused by the deformation is accepted and compensated by the flexible flexure hinge. The flexible flexure hinge connects the first surface layer to the second surface layer in the end section, thus enabling a relative thrust movement or a relative displacement between the first surface layer and the second surface layer when the cross-section of the end section is changed by the actuator device. The elastic connection by means of the flexible flexure hinge reduces the stresses acting on the first surface layer and the second surface layer when the cross-section is changed by the actuator device.

As a result, it is possible to provide an end section of a profile body that can be changed in terms of cross-section and shape, which can be deformed by a relatively small force and therefore a reduced actuator device. At the same time, a continuous first and/or second surface layer can be achieved which, in particular, extends uninterruptedly from the main section to the end section, thus preventing jumps and steps in the flow surface and essentially supporting a laminar boundary layer flow.

According to one embodiment, the flexible flexure hinge extends across the span and forms part of the outer flow surface.

According to one embodiment, it is provided for that the surface layers are formed from a fiber composite material comprising a fiber material and a matrix material embedding the fiber material and/or that the surface layers are formed from a metal material.

Such a fiber composite material may be a CFRP or fiberglass, for example. It is conceivable that the first surface layer and the second surface layer are designed as a single piece, i.e. the first surface layer and the second surface layer extend, for example, from the front edge section, across the main section, to the rear edge section without interruption or joints.

According to one embodiment, it is envisaged that the aerodynamic profile body is a wing and the end section is a rear edge section of the wing.

The task is also solved according to the invention with a flying object according to claim 9, wherein the flying object comprises at least one aerodynamic profile body as described above.

Otherwise, the task is also solved according to the invention by way of the method for changing the profile shape of a wing of an aircraft in flight in accordance with claim 11, wherein the wings of the aircraft are designed as aerodynamic profile bodies according to any of the claims 1 to 9, wherein control signals are generated for the actuator device of the aerodynamic profile bodies for the purpose of changing the profile shape of the wings and transmitted to the actuator device in order to change the profile shape of the wings.

According to one embodiment, it is provided for that flight parameters of the flight are recorded during flight of the aircraft and the control signals are generated as a function of the recorded flight parameters.

According to one embodiment, it is envisaged that the flight parameters are the velocity of the aircraft and/or the height of the aircraft.

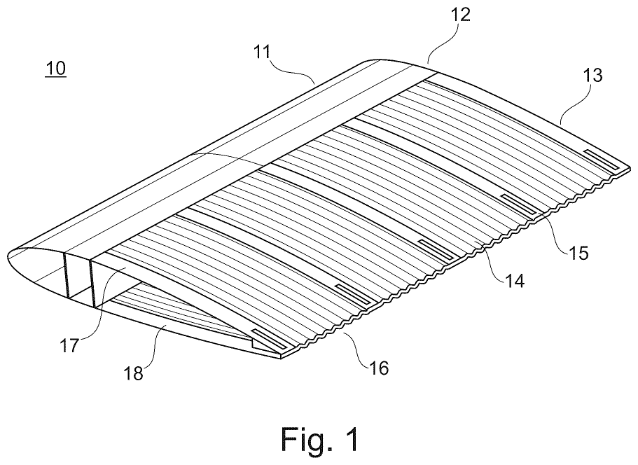

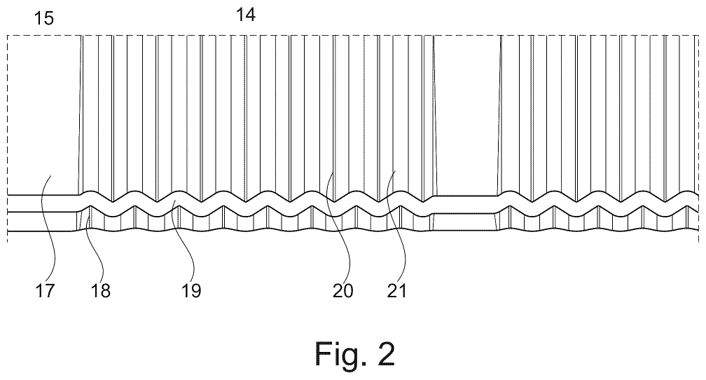

The invention is explained in more detail by means of the attached figures. They show:
FIG. 1 a perspective representation of a section of a wing as a profile body;
FIG. 2 detailed top view of a profile section and connecting section.

FIG. 1 shows a perspective representation of a section of a wing 10, which serves as an example of a profile body within the meaning of the present invention. The wing 10 has a front edge 11 to which a main section 12 and a rear section 13 serving as an end section are joined within the meaning of the present invention.

The rear edge 13 is divided into multiple profile sections 14 with a connecting section 15 between each one.

The profile sections 14 extends from the main section 12 (often referred to as the wing box and shown here relatively short for illustrative purposes) towards the end edge 16, where the flow profile ends. In this case, at least the rear edge 13 is composed of a first surface layer 17 and a second surface layer 18. The connecting sections 15, on the other hand, have a smooth surface and, in particular, do not exhibit a profile shape.

An interior of the wing 10 contains multiple actuators (not shown), which are attached to an inner side of the connecting sections 15. By actuating the actuators, the cross-section of the connecting sections 15 can be changed, for example by bending them downwards or upwards (in relation to the diagram).

The profile sections 14 have a surface profile that extends lengthways in a wing depth direction from the main section 12 to the end edge 16.

If one of the connecting sections 15 is now deflected due to an actuation of the actuators, the adjacent profile section 14 is also deformed, wherein the tensile and/or compressive stresses that occur during deformation can be compensated due to the surface profile of the profile section 14.

Such a profile shape of a profile section 14 is shown in detail in FIG. 2. The surface profile has peaks 20 and troughs 21, which can be referred to as an upper belt 20 and lower belt 21.

At the end edge 16, where the first surface layer 17 and the second surface layer 18 are brought together, there is a flexible flexure hinge 19, the purpose of which is to compensate a displacement of the surface layers 17 and 18 towards each other during deformation.

As can be seen in FIG. 1, the surface profile begins slowly in profile section 14 and gradually increases towards the end edge 16. The value of the surface profile in profile sections 14 thus increases towards the end edge 16 in order to avoid jumps or steps at the transition between the main section 12 and rear edge 13 within profile section 14.

The surface layers 17, 18 can be made of a fiber composite material, which allows for flexible deformation within the system boundaries and aligns with the idea of lightweight construction.

### REFERENCE LIST

10 aerodynamic profile body/wing
11 front edge
12 main section/wing box
13 end section/rear edge
14 profile section
15 connecting section
16 end edge
17 first surface layer
18 second surface layer
19 connection arrangement/flexible flexure hinge
20 upper belt
21 lower belt

1. An aerodynamic profile body with an outer flow surface for flowing through a fluid, comprising:
a profile body comprising a first surface layer and a second surface layer which form at least part of an outer flow surface of the profile body, wherein the first surface layer and the second surface layer are designed to be flexible in an end section of the profile body such that the end section of the profile body is flexible;
a connection arrangement that flexibly connects the first surface layer to the second surface layer of the profile body in the end section of the profile body; and
an actuator device with at least one actuator provided in an interior of the profile body, wherein the actuator device is configured to interact with at least one of the first surface layer and the second surface layer in the end section of the profile body such that a cross-section of the profile body in the end section is changeable by the at least one actuator,
wherein the outer flow surface of the profile body is designed such that at least one of the first surface layer and the second surface layer in the end section of the profile body has, at least in sections, a surface profile that extends parallel to a direction of flow.

2. The aerodynamic profile body according to claim 1, wherein the outer flow surface of the profile body in the end section has at least one of the first surface layer and the second surface layer divided into a plurality of profile sections across a span, each of the plurality of profile sections has a surface profile extending parallel to the direction of flow.

3. The aerodynamic profile body according to claim 2, wherein each of the plurality of profile sections is operatively connected to at least one actuator of the actuator device and is configured to change a particular cross-section of the profile body in the respective profile section of the end section.

4. The aerodynamic profile body according to claim 2, further comprising a connecting section provided between two profile sections, wherein the outer flow surface of the profile body in at least one of the first surface layer and the second surface layer does not have a surface profile in the connecting section.

5. The aerodynamic profile body according to claim 1, wherein a profile thickness of a surface profile of the profile body increases towards the end section.

6. The aerodynamic profile body according to claim 1 wherein the connection arrangement comprises a flexible flexure hinge.

7. The aerodynamic profile body according to claim 6, wherein the flexible flexure hinge extends across a span and forms part of the outer flow surface of the profile body.

8. The aerodynamic profile body according to claim 1 wherein either or both the first surface layer and the second surface layer
are formed from a fiber composite material comprising a fiber material and a matrix material embedding the fiber material, and/or
are formed from a metal material.

9. The aerodynamic profile body according to claim 1 wherein the profile body is configured as a wing and the end section of the profile body is a rear edge section of the wing.

10. A flying object with at least one aerodynamic profile body according to claim 1.

11. A method for changing a profile shape of a wing of an aircraft in flight, wherein the aircraft has wings designed as aerodynamic profile bodies according to claim 1, comprising
generating control signals for the actuator device of the aerodynamic profile bodies for the purpose of changing the profile shape of the wing; and
transmitting to the actuator device in order to change the profile shape of the wing.

12. The method according to claim 11, further comprising recording flight parameters of the aircraft during flight, wherein the control signals are generated as a function of the recorded flight parameters.

13. The method according to claim 12, wherein the flight parameters are selected from the group consisting of velocity of the aircraft, required lift, desired maneuver and/or height of the aircraft.
